(19) United States
(12) Patent Application Publication
(10) Pub. No.: US 2012/0182577 A1
(43) Pub. Date: Jul. 19, 2012

(54) DISPLAY CONTROL APPARATUS AND CONTROL METHOD THEREOF, AND STORAGE MEDIUM

(75) Inventors: Hirohiko Tashiro, Kawasaki-shi (JP); Hiroshi Tanioka, Yokohama-shi (JP); Yoshitaka Oba, Kawasaki-shi (JP); Masayuki Sato, Tokyo (JP); Kenji Hara, Kawasaki-shi (JP)

(73) Assignee: CANON KABUSHIKI KAISHA, Tokyo (JP)

(21) Appl. No.: 13/380,358

(22) PCT Filed: Nov. 2, 2011
(86) PCT No.: PCT/JP2011/075878

§ 371 Date: Dec. 22, 2011

(30) Foreign Application Priority Data
Nov. 29, 2010 (JP) 2010-265429

(51) Int. Cl. G06F 3/12

(52) U.S. Cl. 358/1.15

(57) ABSTRACT

A display control apparatus and a control method for controlling display of a display unit are provided. The display control apparatus detects an orientation of the display unit and controls a display of the display unit in accordance with the detected orientation of the display unit. The screen of the display unit is divided into a first display area, where a display layout is changed in accordance with the orientation of the display unit, and a second display area where a display layout is not changed in accordance with the orientation of the display unit. The display control unit makes the second display area display a first window which changes in accordance with a function to be executed, and makes the first display area display a second window which does not change in accordance with a function to be executed.

### TECHNICAL FIELD

The present invention relates to a display control apparatus for controlling display of a console panel that is attachable to or detachable from an apparatus main unit and controls the apparatus main unit, a control method of the display control apparatus, and a storage medium.

### BACKGROUND ART

Conventionally, among image forming apparatuses, there is an apparatus having a console panel, including a display unit for controlling the image forming apparatus main unit (hereinafter referred to as the main unit), which is attachable to or detachable from the main unit for advanced operability.

Also, there is a display control apparatus which adaptively switches display orientation in accordance with an orientation of a display device (for instance, Japanese Patent Laid-Open No. 11-30969).

In the aforementioned console panel in the conventional art, which is attachable to or detachable from an image forming apparatus, the display orientation is fixed. However, if the console panel can display an image in accordance with the orientation of the console panel, better operability can be provided to users. Meanwhile, an image forming apparatus, such as a multifunction peripheral, requires various complicated setting operation, for instance, for copying or facsimile functions. Therefore, the console panel is generally large, and has a rectangular touch panel or a liquid crystal cell. According to the display control apparatus disclosed in Japanese Patent Laid-Open No. 11-30969, display data in a square display area of a screen can be used commonly in the portrait and landscape orientations, and the operability of the apparatus is consistent in the portrait and landscape orientations. However, for the area outside the square display area, display data cannot be shared for the portrait and landscape orientations, and therefore, an operator must operate differently in the portrait display state and the landscape display state.

### SUMMARY OF INVENTION

An aspect of the present invention is to eliminate the above-mentioned problems with the conventional technology.

A feature of the present invention is to share image data to be displayed on a display unit of a console panel as much as possible with respect to the portrait and landscape orientations of the console panel, thereby prevent an increase of the memory area which stores the image data to be displayed.

Furthermore, a feature of the present invention is to display a console panel window, having better operability, with a smaller amount of image data, in accordance with an orientation of a console panel operated by an operator.

According to an aspect of the present invention, there is provided a display control apparatus for controlling display of a display unit, comprising: detection means for detecting an orientation of the display unit; and display control means for controlling display of the display unit in accordance with the orientation of the display unit, which is detected by the detection means, wherein a screen of the display unit is divided into a first display area, where a display layout is changed in accordance with the orientation of the display unit, and a second display area where a display layout is not changed in accordance with the orientation of the display unit, and the display control means does not let the first display area display, but makes the second display area display a first window which changes in accordance with a function to be executed, and does not let the second display area display, but makes the first display area display a second window which does not change in accordance with a function to be executed.

According to an aspect of the present invention, there is provided a control method of a display control apparatus for controlling display of a display unit, comprising: a detection step of detecting an orientation of the display unit; and a display control step of controlling display of the display unit in accordance with the orientation of the display unit, which is detected in the detection step, wherein a screen of the display unit is divided into a first display area, where a display layout is changed in accordance with the orientation of the display unit, and a second display area where a display layout is not changed in accordance with the orientation of the display unit, and the display control step does not let the first display area display, but makes the second display area display a first window which changes in accordance with a function to be executed, and does not let the second display area display, but makes the first display area display a second window which does not change in accordance with a function to be executed.

Further features and aspects of the present invention will become apparent from the following description of exemplary embodiments, with reference to the attached drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 depicts a schematic view of a printing system, comprising an image forming apparatus (printing apparatus) according to an embodiment;

FIG. 2 is a block diagram showing a configuration of a main unit, a home position, and a console panel;

FIG. 3 is a flowchart for describing image display processing of a console panel according to the embodiment;

FIGS. 4A to 4D depict explanatory views of a display orientation in accordance with an orientation of a console panel;

FIGS. 5A and 5B depict views illustrating examples of a user interface (UI) window displayed on a common input display area;

FIGS. 6A and 6B depict views illustrating examples of a key operation window, which is displayed in a vertical or horizontal input display area of FIGS. 4A to 4D;

FIG. 7 is a flowchart for describing processing executed by the main unit according to the embodiment;

FIG. 8 depicts a view illustrating an example of a FAX transmission window in a case where the console panel is operated in the portrait orientation;

FIG. 9 depicts a view illustrating an example of a display window of a FAX address table in a case where the console panel is operated in the portrait orientation;

FIG. 10 depicts a view illustrating an example of a FAX address window displayed in a case where the console panel is operated in the portrait orientation;

FIGS. 11A and 11B depict views illustrating examples of a FAX transmission window and an address display window in a case where the console panel is operated in the landscape orientation;

FIG. 12 depicts a view illustrating an example of a FAX address window displayed in a case where the console panel is operated in the portrait orientation;

FIGS. 13A and 13B depict explanatory views of a UI window as another embodiment, which is displayed in the common input display area;

FIG. 14 depicts a view showing a key operation window as another embodiment, which is displayed in a horizontal input display area;

FIG. 15A is a block diagram of a console panel, comprising a three-dimensional acceleration sensor in addition to a tilt sensor, and a home position according to another embodiment;

FIG. 15B is a block diagram of a console panel comprising a three-dimensional gyro sensor, and a home position according to another embodiment; and

FIG. 16 is a flowchart for describing display processing of a console panel according to another embodiment of the present invention.

### DESCRIPTION OF EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

Although the present embodiment will describe an image forming apparatus as an example of a display control apparatus, the present invention is not limited to this.

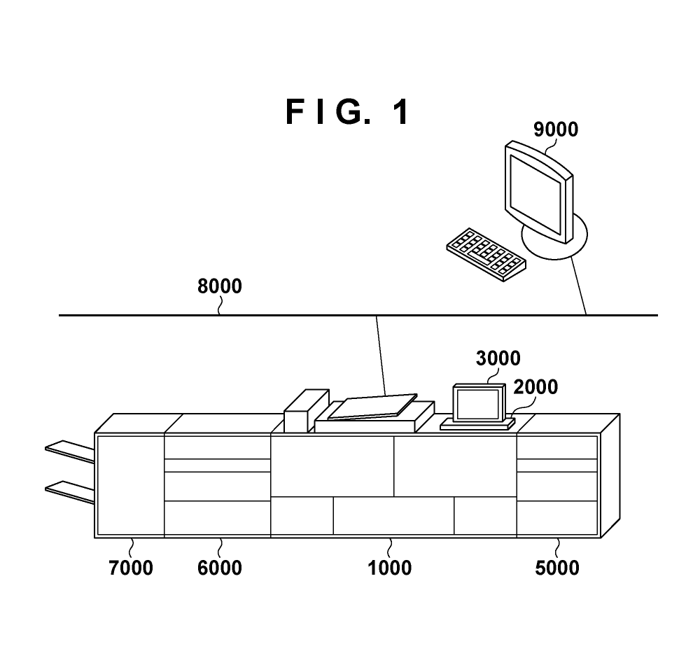

FIG. 1 depicts a schematic view of a printing system, comprising an image forming apparatus according to an embodiment of the present invention.

The image forming apparatus according to the present embodiment is a so-called print-on-demand (POD) machine, which can combine various options such as saddle stitching, cutting, folding and the like, thereby meeting a variety of printing and binding requests. In this image forming apparatus shown as an example, an image forming apparatus main unit (hereinafter referred to as the main unit) 1000 is combined with a paper feed deck 5000, a binder 6000, and a finisher 7000.

The main unit 1000 is connected to a personal computer 9000 through a LAN 8000. The personal computer 9000 generates a print job including each page data of a document, and the setting such as binding, cutting, folding and the like. The print job generated in this manner is transmitted to the main unit 1000 through the LAN 8000, and then processing such as printing and binding is executed in accordance with the print job.

Furthermore, in FIG. 1, a console panel 3000 which is attachable to or detachable from the main unit 1000 and comprises a display unit, which is a feature of the present embodiment, is mounted to the home position 2000 of the main unit 1000. The console panel 3000 is configured in a way that, when it is mounted to the home position 2000 of the main unit 1000, the built-in battery is charged by the power supplied from the main unit 1000 through the home position 2000. Note that, since the paper feed deck 5000, binder 6000, and finisher 7000 do not directly concern the present invention, a detailed description is omitted.

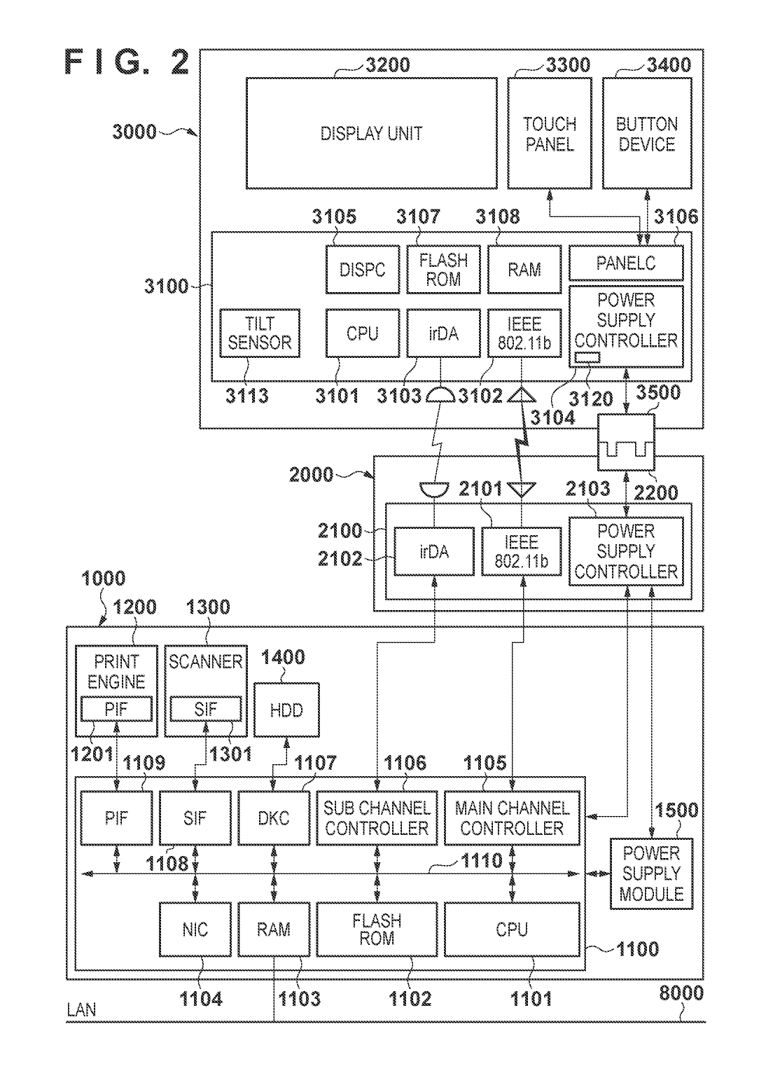

FIG. 2 is a block diagram showing a configuration of the main unit 1000, the home position 2000, and the console panel 3000. Hereinafter, modules that respectively constitute the main unit 1000, the home position 2000, and the console panel 3000 will be described.

First, the main unit 1000 is described.

As shown in FIG. 2, the main unit 1000 comprises a controller board 1100, a print engine 1200, a scanner 1300, a hard disk drive (HDD) 1400, and a power supply module 1500. Each of these units operates with the power supplied by the power supply module 1500.

The controller board 1100 comprises a CPU 1101, flash ROM 1102, RAM 1103, a network interface card (NIC) 1104, a main channel controller 1105, and a sub channel controller 1106. It further comprises a disk controller (DKC) 1107, a scanner interface (SIF) 1108, and a printer interface (PIF) 1109. These devices 1101 to 1109 are connected to the CPU 1101 through a bus 1110.

The CPU 1101 is a processor, which comprehensively controls each of the devices connected to the bus 1110, and executes a control program stored in the flash ROM 1102 or the HDD 1400. The RAM 1103 is used as a main memory or work area of the CPU 1101. The NIC 1104 performs bi-directional data communication with the personal computer 9000 and other image forming apparatuses through the LAN 8000. The HDD 1400, which is accessed through the DKC 1107, not only stores a control program, but is also used as a temporary storage of image data.

The scanner 1300 comprises a read sensor, a document feed mechanism and the like (both not shown). The read sensor, document feed mechanism and the like are controlled in accordance with software, which is executed by the CPU 1101 through the SIF 1108 incorporated in the controller board 1100 and the SIF 1301 incorporated in the scanner 1300. As a result, a document is read by the read sensor, and the obtained data is transferred to the controller board 1100 through the SIF 1301 and SIF 1108.

The print engine 1200 comprises an electrophotographic printing unit, a print sheet cassette, a paper conveyance unit, and the like (all not shown). A print request based on a print job is transmitted from the controller board 1100 to the print engine 1200 through the PIF 1109 and the PIF 1201 incorporated in the print engine 1200. The printing unit, the paper conveyance unit, and the like are similarly controlled in accordance with a program executed by the CPU 1101 through the PIF 1109 and the PIF 1201. As a result, an image in accordance with the print request is formed (printed) on paper.

The main channel controller 1105 and the sub channel controller 1106 are used when data communication is performed between the main unit 1000 and the console panel 3000 which is attachable to or detachable from the main unit 1000.

Next, the home position 2000 is described.

As shown in FIG. 2, the home position 2000 mainly comprises a main board 2100 and a connector 2200. The main board 2100 mainly comprises an IEEE 802.11b module 2101, an irDA module 2102, and a power supply controller 2103. The IEEE 802.11b module 2101 is connected with the main channel controller 1105 of the controller board 1100, and intermediates wireless communication between the console panel 3000 and the main unit based on a request from the controller board 1100. The irDA module 2102 is connected with the sub channel controller 1106 of the controller board 1100, and intermediates infrared communication between the console panel 3000 and the main unit based on a request from the controller board 1100. The power supply controller 2103 is connected with the power supply module 1500. The IEEE 802.11b module 2101 and the irDA module 2102 receive power supply through the power supply controller 2103. The power supply controller 2103 is also connected with the connector 2200 for supplying electric power to the console panel 3000 when a connector 3500 of the console panel 3000 is in a contact state. Moreover, the power supply controller 2103 monitors the power supply state for detecting whether or not the console panel 3000 is mounted to the home position 2000, and transmits the detected result to the controller board 1100. Note that, when it is recognized that the console panel 3000 is mounted to the home position 2000 (the main unit) by detecting the mounted state, the orientation of the console panel 3000 is always set as a landscape orientation, regardless of an orientation of the console panel 3000 detected by the orientation detection unit, which will be described later.

Next, the console panel 3000 is described.

The attachable/detachable console panel 3000 comprises a main board 3100, a display unit (LCD) 3200, a touch panel 3300, a button device 3400, and a connector 3500. The main board 3100 comprises a CPU 3101, an IEEE 802.11b module 3102, an irDA module 3103, and a power supply controller 3104. The main board 3100 further comprises a display controller (DISPC) 3105, a panel controller (PANELC) 3106, flash ROM 3107, RAM 3108, and a tilt sensor 3113 for detecting an orientation of the console panel 3000. Each of the devices 3101 to 3108 is connected by a bus (not shown), as similar to the controller board 1100. The display unit 3200 and the touch panel 3300 are about 12-inch size, wherein touch input is possible in the same area as the display area having a number of pixels (1024×768 pixels). The following description is provided, assuming that touch input is possible at all key display positions which are displayed on the display unit 3200.

The CPU 3101 is a processor, which comprehensively controls each of the devices connected to the bus (not shown), and executes a control program stored in the flash ROM 3107. The RAM 3108 serves as a main memory or work area of the CPU 3101, or a storage area of video data displayed on the display unit 3200. The display controller (DISPC) 3105 transfers, in accordance with a request from the CPU 3101, a video image developed in the RAM 3108 to the display unit 3200, while controlling the display unit 3200. As a result, an image is displayed on the display unit 3200. The panel controller (PANELC) 3106 controls the touch panel 3300 and button device 3400 in accordance with a request from the CPU 3101. By the control, a depressed position of the touch panel 3300, a key code of the depressed button device 3400 and the like are transmitted to the CPU 3101. The power supply controller 3104, which is connected with the connector 3500, receives power supply from the power supply module 1500 of the main unit 1000 when the connector 3500 is connected to the connector 2200 of the home position 2000. By this, the power supply controller 3104 supplies power to the entire console panel 3000, while charging a rechargeable battery 3120 which is connected to the power supply controller 3104.

The IEEE 802.11b module 3102 establishes wireless communication with the IEEE 802.11b module 2101 of the home position 2000 based on the control of the CPU 3101, thereby intermediating communication with the main unit 1000. The irDA module 3103 establishes infrared communication with the irDA module 2102 of the home position 2000, thereby intermediating communication with the main unit 1000. The tilt sensor 3113 detects whether the console panel 3000 is in a landscape orientation (the display unit 3200 is in a state of landscape display) or in a portrait orientation (the display unit 3200 is in a state of portrait display).

Next, wireless communication as a main channel according to the present embodiment is described.

As briefly mentioned in the description of FIG. 2, in the present embodiment, wireless communication in a main channel is performed in conformity to the known wireless standard IEEE 802.11b. More specifically, in the system according to the present embodiment, wireless communication is performed in the infrastructure mode, where the main unit 1000 serves as an access point (AP) and the console panel 3000 serves as a terminal.

When there are a plurality of main units within the radio wave range of the console panel 3000, ESSIDs of the plurality of communicable main units are displayed on the display unit 3200 of the console panel 3000 so that one of them can be selected, as in an existing personal computer.

After communication is established with the communication target by an association process, the console panel 3000 according to the present embodiment operates as a thin client employing a screen transfer method. In other words, most of the actual processing and video image generation are executed by the CPU 1101 of the main unit 1000. The generated video data is wirelessly transmitted from the main unit 1000 to the console panel 3000 according to a predetermined protocol. The CPU 3101 of the console panel 3000, which receives the video data, develops the received video data in the RAM 3108, and displays an image in the display unit 3200 by controlling the DISPC 3105. In other words, most of the status management of the main unit 1000, print signal generation and so forth are executed by the CPU 1101 of the main unit 1000. The status of the main unit 1000 is wirelessly transmitted from the main unit 1000 to the console panel 3000 according to a predetermined protocol.

Meanwhile, information related to user operation on the touch panel 3300 and button device 3400 in the console panel 3000 is also transmitted wirelessly from the console panel 3000 to the main unit 1000 according to a predetermined protocol. The information related to user operation includes a depressed position of the touch panel 3300, a key code of the depressed button of the button device 3400 and the like. The CPU 1101 of the main unit 1000, which has received the information related to user operation, controls each operation based on the transmitted information, updates video data if necessary, and transmits video data to the console panel 3000 as mentioned above.

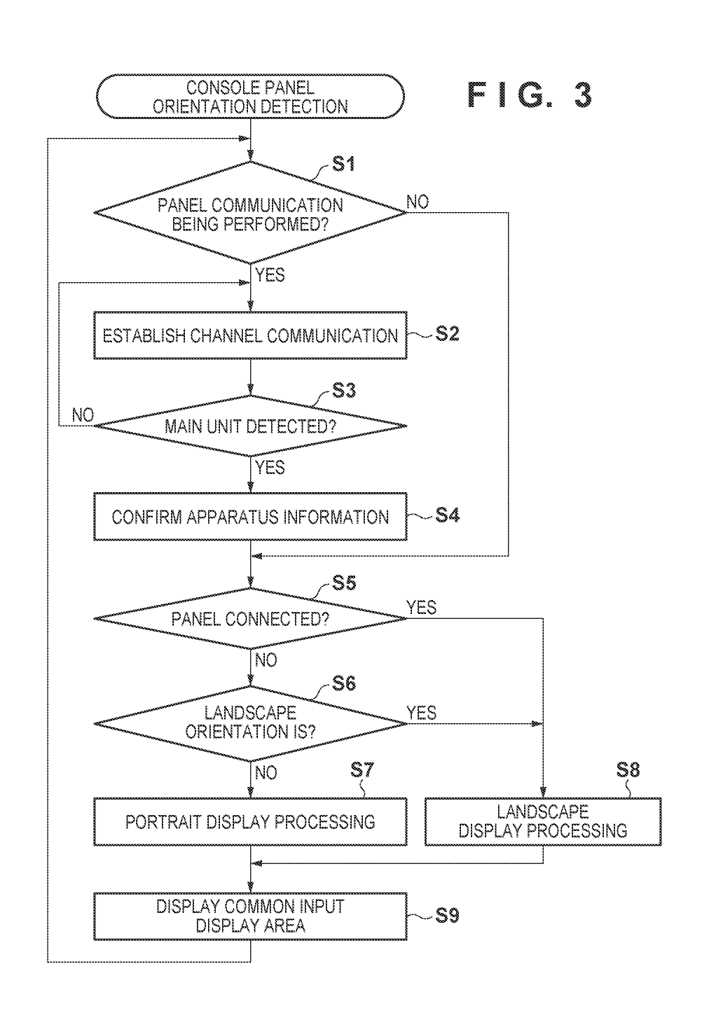

FIG. 3 is a flowchart for describing display processing of the console panel 3000 according to the present embodiment. Note that a program, which executes the processing described in the flowchart, is stored in the flash ROM 3107, and executed under the control of the CPU 3101.

In step S1, the CPU 3101 of the console panel 3000 determines the wireless communication state of the main channel for determining whether or not wireless communication is being performed between the console panel 3000 and the main unit 1000. When it is determined in step S1 that wireless communication in the main channel is not being performed, the processing proceeds to step S2, where a request for establishing main channel communication with the main unit 1000 is transmitted to the main unit 1000. Note that in a case where there are a plurality of main units within the radio wave range of the main channel, ESSIDs of the plurality of communicable main units are displayed on the display unit 3200 for having a user select one of them, and the request is transmitted to the main unit having the selected ESSID. Then, in step S3, the CPU 3101 determines whether or not the main unit 1000 has been detected by whether or not it has received a communication permission response from the main unit 1000. Steps S2 and S3 are repeated until the main unit 1000 is detected.

When it is determined that the main unit 1000 has been detected in step S3, the CPU 3101 establishes main channel communication with the main unit 1000, and the processing proceeds to step S4. In step S4, the CPU 3101 confirms apparatus information, such as an apparatus ID of the main unit 1000, effective functions and the like. More specifically, the CPU 3101 transmits a confirmation request of the apparatus information to the main unit 1000 (a request for confirming apparatus information, such as an apparatus ID of the main unit 1000, effective functions and the like), and receives apparatus information from the main unit 1000, then the processing proceeds to step S5. Meanwhile, when it is determined in step S1 that wireless communication in the main channel is being performed with the main unit 1000, the CPU 3101 proceeds the processing to step S5.

In step S5, the CPU 3101 determines whether or not the console panel 3000 is placed at the home position 2000 of the main unit 1000 and the console panel 3000 is connected with the main unit 1000. When it is determined that the console panel 3000 is connected with the main unit 1000, the CPU 3101 branches to step S8, where panel display in a landscape orientation is uniquely performed. On the other hand, when it is determined that the console panel 3000 is not connected with the main unit 1000, the CPU 3101 proceeds the processing to step S6. In step S6, an operator has detached the console panel 3000 from the main unit 1000, and the CPU 3101 determines based on the output from the tilt sensor 3113 whether or not the orientation of the console panel 3000 is a landscape orientation. When it is determined that the orientation is a landscape orientation based on the output from the tilt sensor 3113, the processing proceeds to step S8, where display processing in a landscape orientation is performed. Then, the processing proceeds to display processing of a common input display area in step S9. Meanwhile, when it is determined that the orientation is a portrait orientation based on the output from the tilt sensor 3113, the processing proceeds to step S7, where display processing in a portrait orientation is performed, and then the processing proceeds to the display processing of the common input display area in step S9. The processing from steps S1 to S9 is repeated as long as electric power is supplied from the power supply controller 3104.

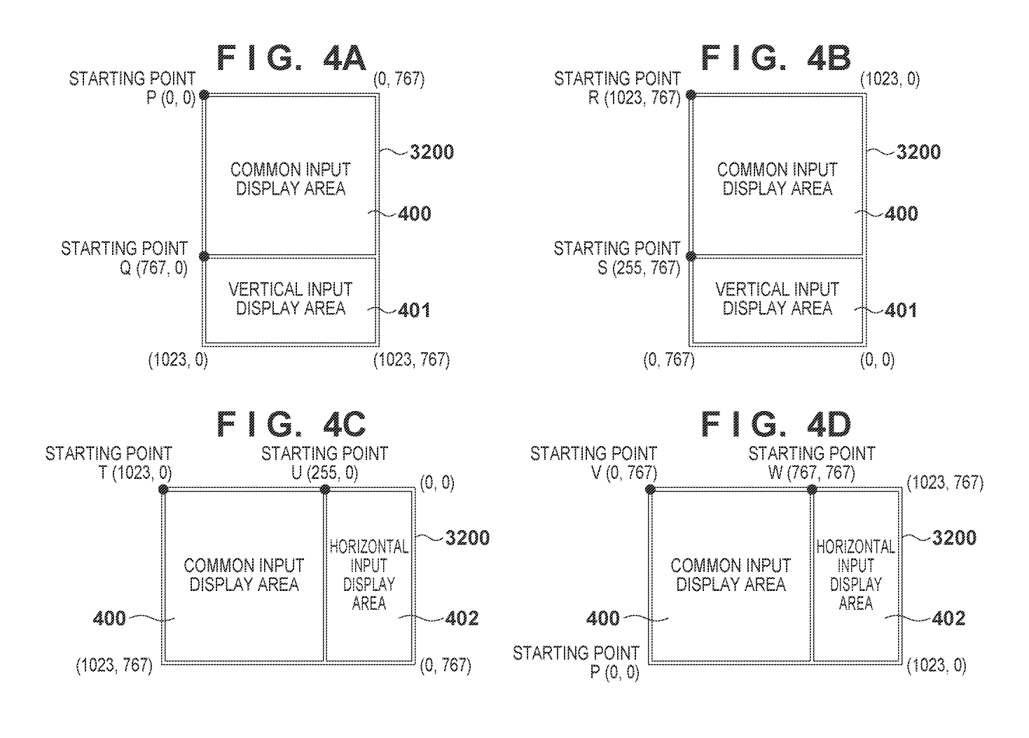

FIGS. 4A to 4D depict explanatory views of a display orientation in accordance with an orientation of the console panel 3000. FIGS. 4A and 4B show a case where the orientation of the console panel 3000, which is detected by the tilt sensor 3113, is portrait, while FIGS. 4C and 4D show a case where the orientation of the console panel 3000 is landscape. In the present embodiment, the display area of the display unit 3200 comprises a substantially square common input display area 400 and a vertical or horizontal input display area 401 or 402. In the common input display area 400, various UI windows are displayed in a given orientation, which does not depend on the orientation of the console panel 3000. With the use of the UI windows, various data input and display can be performed. In the vertical or horizontal input display area 401 or 402, a fixed key operation window is displayed in accordance with the portrait or landscape orientation of the console panel 3000, separately from the UI window of the common input display area 400. By key operation using the key operation window, an instruction can quickly be inputted.

In FIG. 4A, assume that the starting point of the common input display area 400 is P(0, 0), and that the starting point of the vertical input display area 401 is Q(767, 0). Assume that the display unit 3200 of the console panel 3000 according to the present embodiment is a rectangle having a size of 1024×768 pixels, the common input display area 400 is a square having a size of 768×768 pixels, and the vertical input display area 401 has a size of 768×256 pixels.

FIG. 4D shows a state where the console panel 3000 is rotated 90 degrees to the left from the state of FIG. 4A. FIG. 4B shows a state where the console panel 3000 is rotated 180 degrees from the state of FIG. 4A. FIG. 4C shows a state where the console panel 3000 is further rotated 90 degrees to the left from the state of FIG. 4B. Assume that the horizontal input display area 402 in FIG. 4C has a size of 256×768 pixels. Similarly, in other three orientations, in accordance with the result detected by the tilt sensor 3113, the common input display area 400, vertical input display area 401, and horizontal input display area 402 are displayed respectively from the starting point shown in FIG. 4B to 4D.

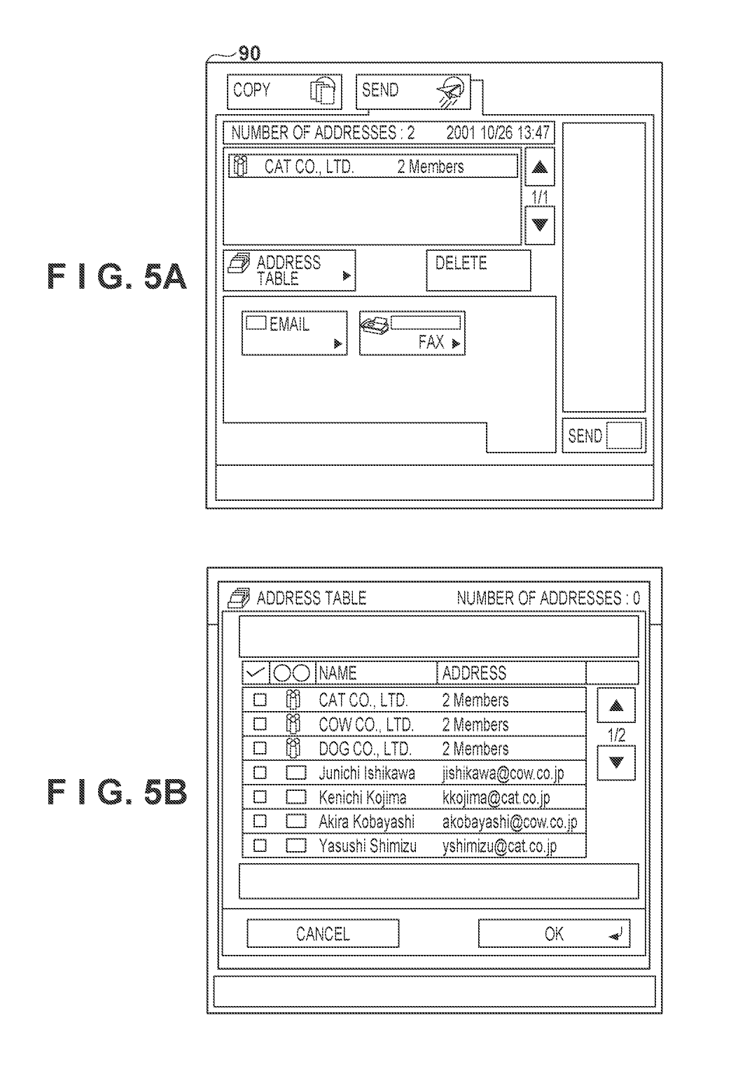

FIGS. 5A and 5B show UI windows displayed on the common input display area 400 of FIGS. 4A to 4D.

FIG. 5A shows a UI window displayed in the common input display area 400, in a case where a FAX transmission function is selected in a basic mode window (not shown). The window data is stored in a specific memory area of the flash ROM 3107, and is displayed by developing the data for 768×768 pixels from an address of the RAM 3108, which corresponds to the starting point of the common input display area 400 of the display unit 3200. Further, FIG. 5B shows a UI window displayed in the common input display area 400 for showing a FAX transmission address table. The window data is also stored in the flash ROM 3107, and is displayed by developing the data for 768×768 pixels from an address of the RAM 3108, which corresponds to the starting point of the common input display area 400 of the display unit 3200. Note that numeral 90 in FIG. 5A indicates a starting point of the window display.

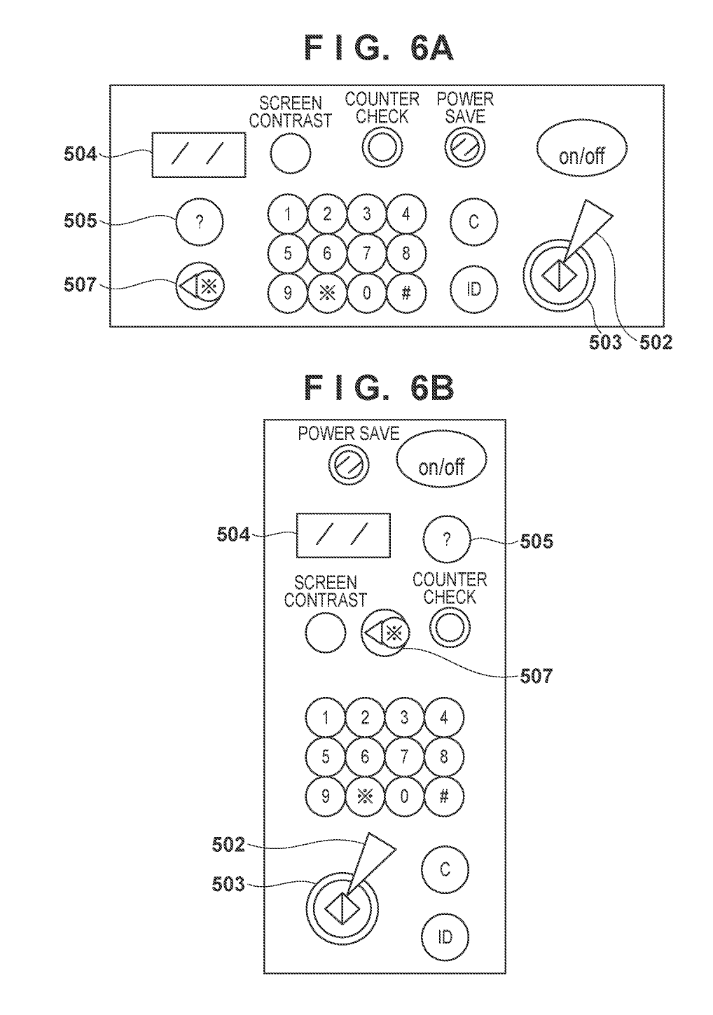

FIGS. 6A and 6B show windows of a key operation area, each of which is displayed in the vertical or horizontal input display area shown in FIGS. 4A to 4D. Items of these window data are stored in a specific memory area of the flash ROM 3107.

FIG. 6A shows a window displayed in the vertical input display area 401. The vertical input display area 401 includes numeric keys used for inputting various numbers on the UI window of the common input display area 400, such as a number of copies to be made, a start key 503, and a stop key 502. A reset key 504 resets display of the common input display area 400 to an initial setting window. A navigation key 505 is provided for having the common input display area 400 display a guide UI window, such as an operation procedure. A register key 507 is provided for registering various initial setting in the main unit 1000. The window data is stored in the flash ROM 3107, and displayed by developing the data for 768×256 pixels in the RAM 3108. Similarly, FIG. 6B shows a key operation window, where the same keys as in FIG. 6A in a different arrangement are displayed in the horizontal input display area 402.

As described above, in accordance with the orientation detected by the tilt sensor 3113, if it is a portrait orientation, for instance, the vertical input display area 401 shown in FIG. 6A is displayed in step S7 in FIG. 3. If the tilt sensor 3113 detects a landscape orientation, the horizontal input display area 402 shown in FIG. 6B is displayed in step S8 in FIG. 3.

The window of the vertical or horizontal input display area 401 or 402 in FIGS. 6A and 6B is realized by displaying keys, which have conventionally been used as fixed hard keys in a console unit of the main unit 1000, in the touch-key window of the display unit 3200. Therefore, regardless of the UI window displayed in the common input display area 400, the vertical or horizontal input display area 401 or 402 must always be displayed on the display unit 3200 in order to control the main unit 1000. For this, in the present embodiment, display data respectively corresponding to portrait and landscape orientations is stored in the flash ROM 3107 as the display data of the vertical or horizontal input display area 401 or 402. The data shown in FIGS. 6A and 6B is the only image data displayed in the vertical and horizontal input display areas 401 and 402. Therefore, compared to hundreds of items of UI window data of the common input display area 400 that are displayed commonly for the portrait or landscape display, the amount of display data in the vertical or horizontal input display area 401 or 402 is small enough to be substantially negligible.

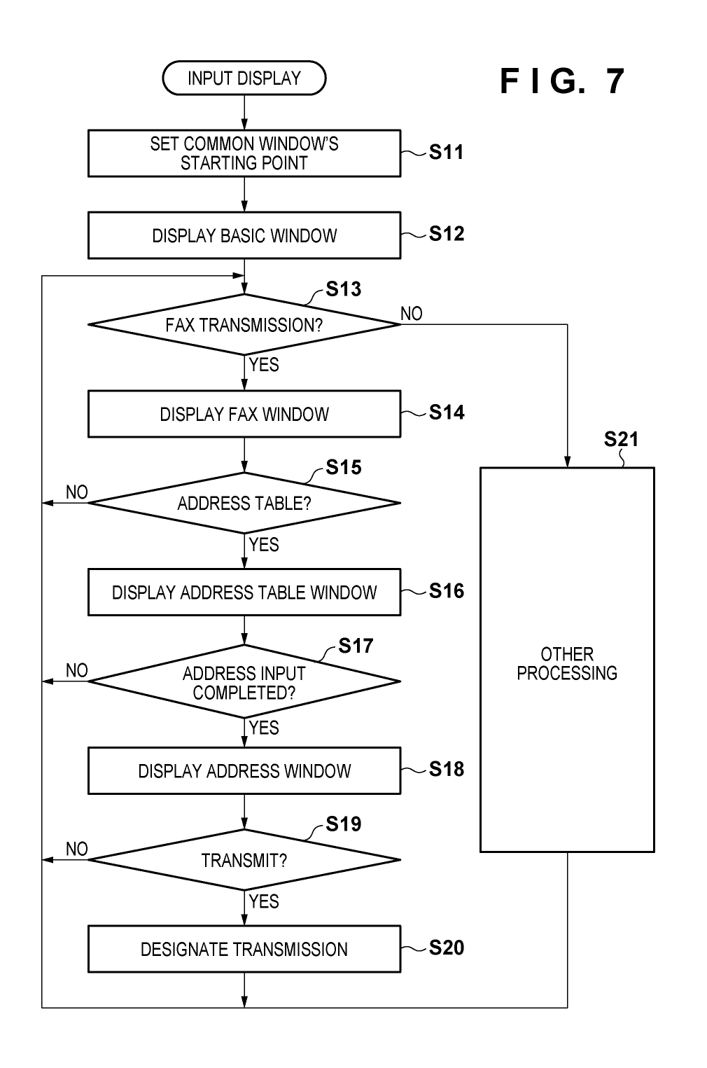

Next, display processing in the main unit 1000 is described with reference to the flowchart in FIG. 7.

FIG. 7 is a flowchart for describing processing executed by the main unit 1000 according to the present embodiment. The program which executes the processing is stored in the flash ROM 1102, and executed under the control of the CPU 1101.

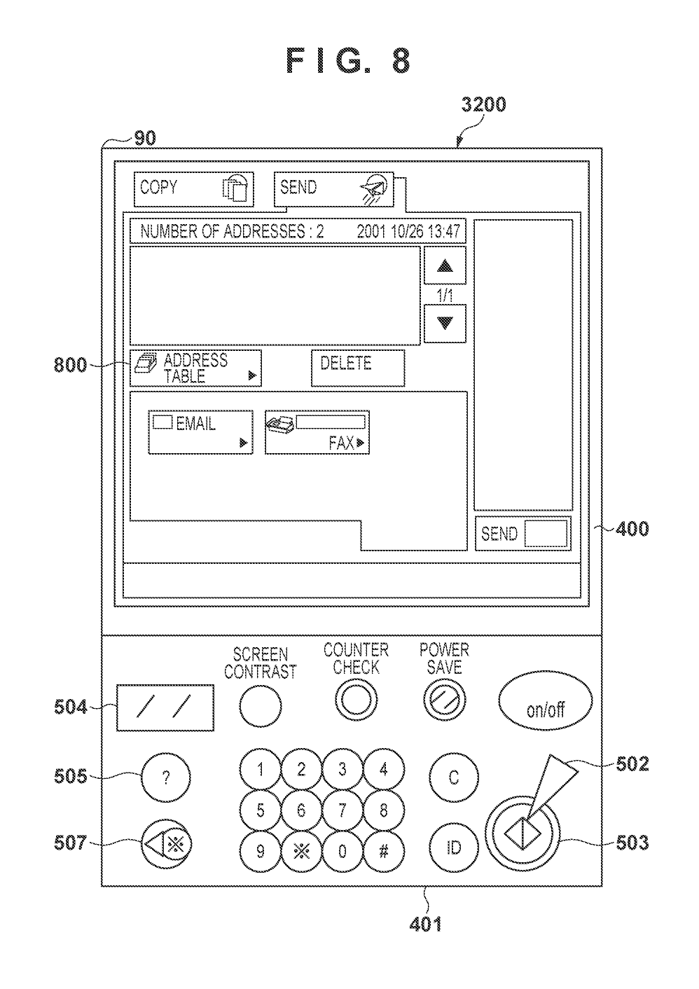

In step S11, in accordance with an orientation of the console panel 3000, the starting address of UI window display data to be displayed in the common input display area 400 is set in one of the starting points P, R, T or V shown in FIGS. 4A to 4D. If it is a portrait orientation as shown in FIG. 4A, an address (0, 0) of the starting point P is set. Then, in step S12, the UI window data of the common input display area 400 to be displayed is developed from the flash ROM 3107 in a way that the starting point 90 of the image data in the common input display area 400 matches an address corresponding to the starting point P in the RAM 3108 when 768×768 pixels are displayed. In this manner, a basic UI window (not shown) is displayed in the common input display area 400 of the display unit 3200. Next, in step S13, it is determined whether or not an operator has selected fax transmission by operating the basic UI window. If FAX transmission is selected, the processing proceeds to step S14, and if not, the processing proceeds to step S21 where the selected processing is executed. In step S14, a FAX window shown in FIG. 8, which corresponds to the FAX transmission function selected in step S13, and which corresponds to a case that the console panel 3000 is in a portrait orientation as shown in FIG. 4A, is selected from a plurality of basic windows and displayed.

Note that, in FIG. 8, a FAX transmission UI window shown in FIG. 5A is displayed in the common input display area 400, while a key operation window including the keys shown in FIG. 6A is displayed in the vertical input display area 401. In FIG. 8, components that are common to FIGS. 5A and 6A are indicated by the same symbols.

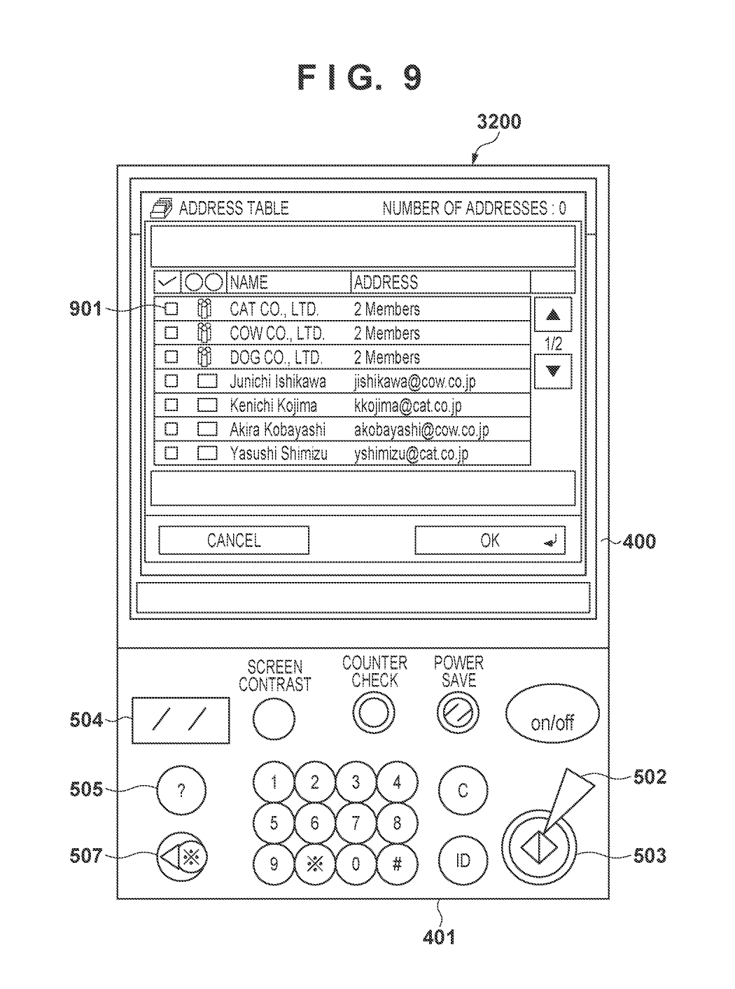

Next, in step S15, it is determined whether or not an address table key 800 (FIG. 8) in the FAX mode window has been depressed. If it is determined that the address table key 800 is depressed, then in step S16, an address table window shown in FIG. 9, which corresponds to the address table function selected in step S15, is displayed in the common input display area 400.

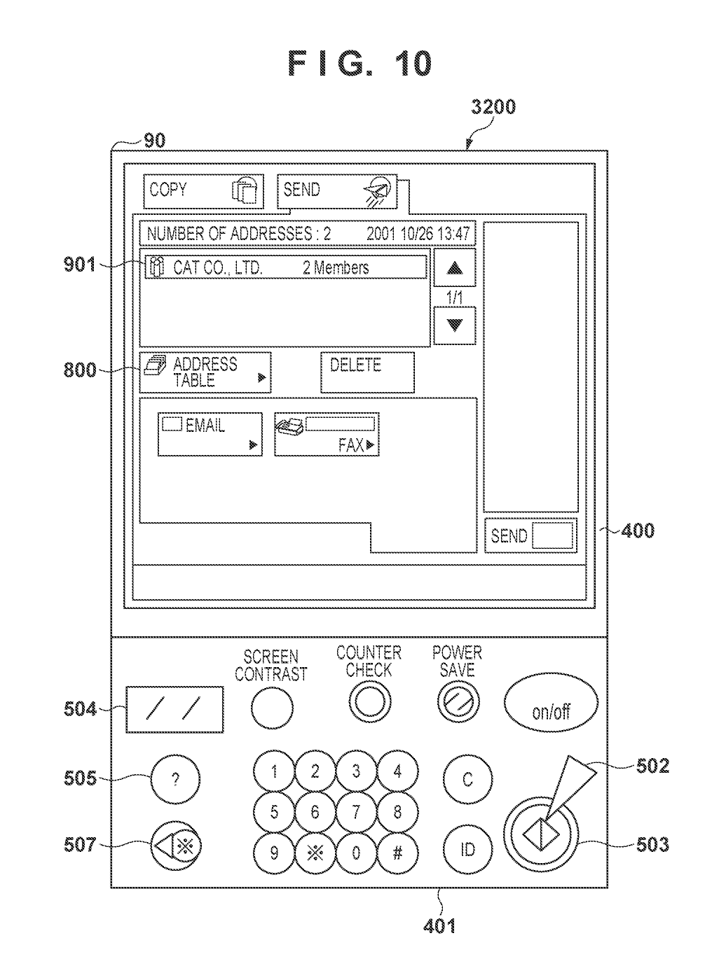

FIG. 9 shows a state where the common input display area 400 displayed at the starting point P is replaced by the FAX transmission address table window in FIG. 5B. Further, when an address 901 is selected in the address table window, the processing proceeds from step S17 to step S18, and the window of the common input display area 400 is switched to the address window shown in FIG. 10.

FIG. 10 shows an example of FAX address window display. In FIG. 10, the address 901 designated in FIG. 9 is displayed in the address display area.

In the window in FIG. 10, when the start key 503 in the window of the vertical input display area 401 is depressed, the processing proceeds from step S19 to S20, and the CPU 3101 instructs FAX transmission to the set address.

Note that, in a case where the tilt sensor 3113 detects a portrait orientation as shown in FIG. 4B, the starting point of display data in the common input display area 400 is R(1023, 767). In this case, the windows also shift in accordance with FIGS. 8 to 10 as described above. Although the window display is the same, the orientation in FIG. 4B corresponds to the orientation in which the console panel 3000 is rotated 180 degrees from the orientation of FIG. 4A. Therefore, by developing the window data, stored in the flash ROM 3107, in compliance with the starting point R(1023, 767) in the RAM 3108, the window display can follow the 180-degree rotation of the console panel 3000.

Next described is a case where the tilt sensor 3113 detects that the console panel 3000 is in a landscape orientation as shown in FIG. 4C.

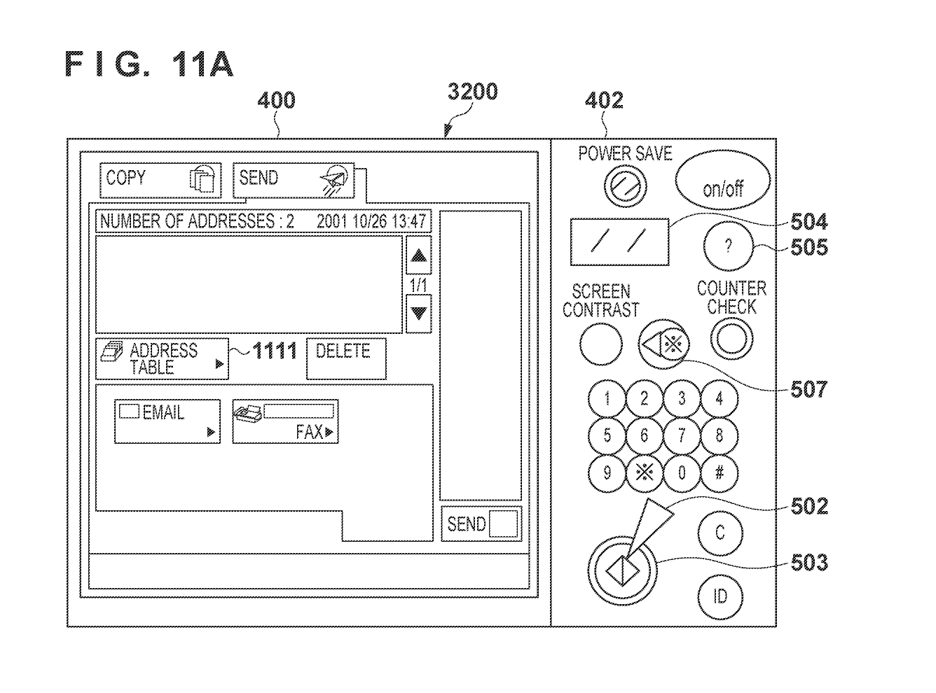

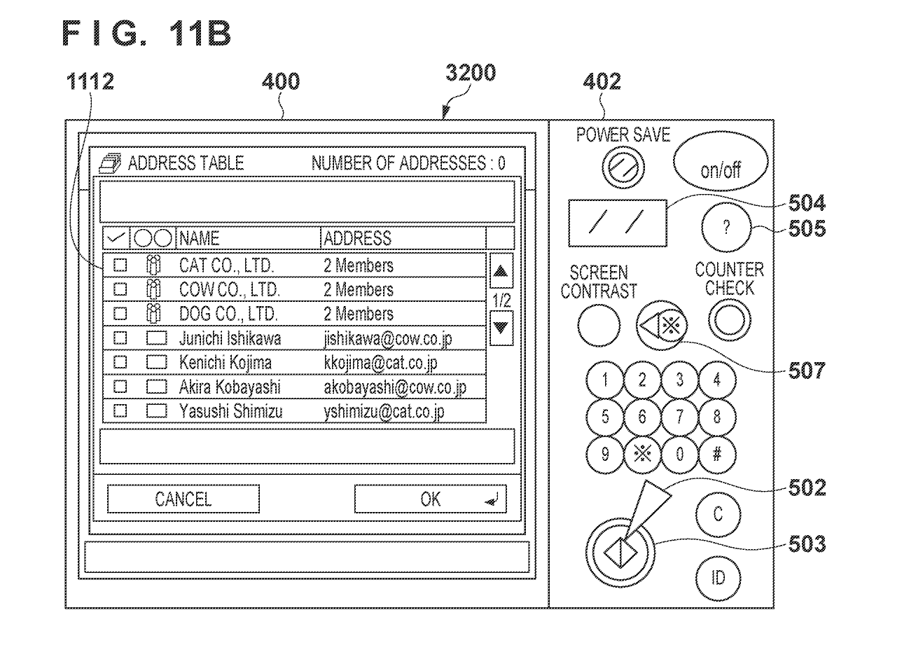

In a case where the console panel has an orientation shown in FIG. 4C, the aforementioned FAX mode window (FIG. 5A) is developed in the RAM 3108 in the direction from the starting point T(1023, 0) to the diagonal point (0, 767). In this case, the window in FIG. 11A is displayed as the FAX window displayed in step S14 in FIG. 7. In the horizontal input display area 402, a key operation window including the keys shown in FIG. 6B is displayed. A UI window is displayed in the common input display area 400, using the same display data as the data shown in FIG. 5A. Therefore, the amount of display data stored in the flash ROM 3107 can be reduced to half, compared to the case of storing dedicated data for each of the portrait and landscape orientations; as a result, the embodiment can be achieved at low cost. Particularly in a multifunction apparatus having many functions and settings, the number of UI windows or the like displayed in the common input display area 400 is enormous. Therefore, a profound effect is achieved by the configuration of the present embodiment.

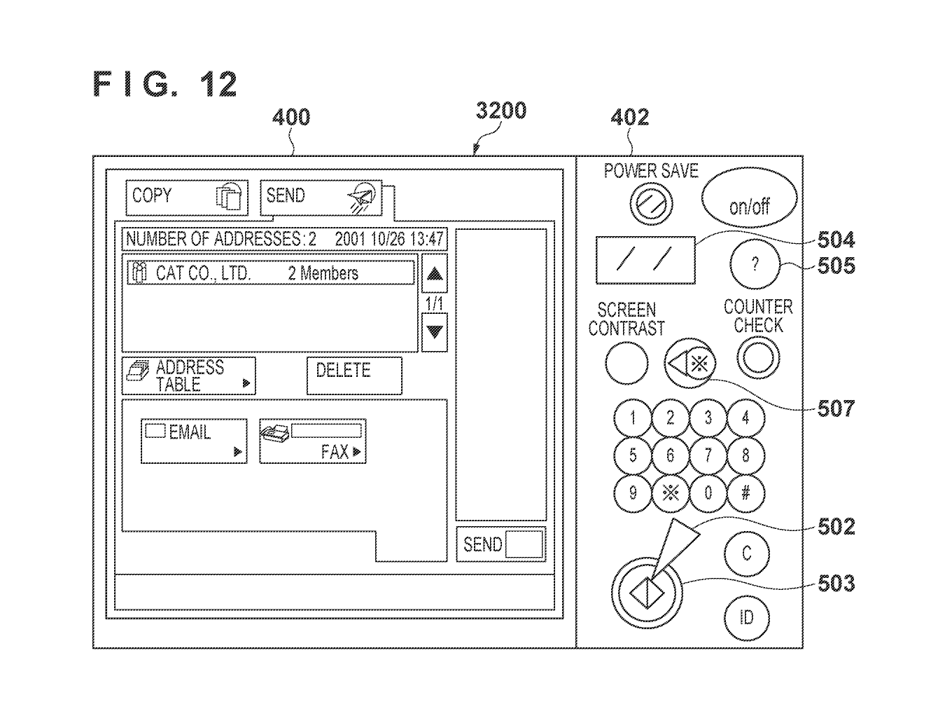

When an address table button 1111 is depressed in the state in FIG. 11A, the window changes to a display shown in FIG. 11B. FIG. 11B corresponds to the aforementioned address table display window shown in FIG. 5B. When an address 1112 is selected here, the processing proceeds to step S18 in FIG. 7. In the common input display area 400, a UI window shown in FIG. 12, which corresponds to the aforementioned FAX address window shown in FIG. 10, is displayed, and an address is set. Here, when the start key 503 in the horizontal input display area 402 is depressed, the processing proceeds to step S20 in FIG. 7, and the CPU 3101 notifies FAX transmission designation together with the set address.

As set forth above, according to the present embodiment, a screen of the display unit 3200 of the console panel 3000 is divided into the common input display area 400 and the vertical or horizontal input display area 401 or 402. For displaying a UI window in the common input display area 400 in accordance with an orientation, common display data is used for portrait and landscape orientations. Moreover, in the vertical and horizontal input display areas 401 and 402, a substantially fixed key operation window is displayed. By virtue of this configuration, the vertical and horizontal input display areas 401 and 402 can display a key operation window in accordance with the portrait or landscape orientation, independent of the UI window of the common input display area 400, and can receive user's input.

As described above, since the common input display area 400 can display a UI window using common display data for either a portrait or landscape orientation, it is possible to realize operation (UI) window display without largely increasing display data along with increased input items. Furthermore, in either use of portrait or landscape orientation, substantially the same key-input operability can be maintained in the vertical and horizontal input display areas 401 and 402; therefore, improved user operability can be achieved.

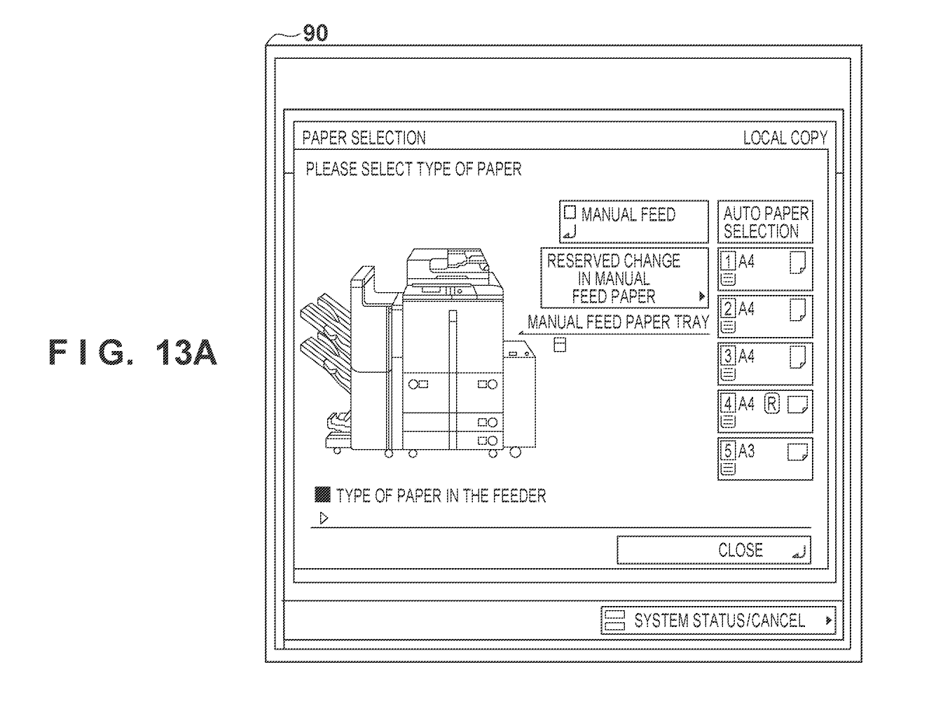

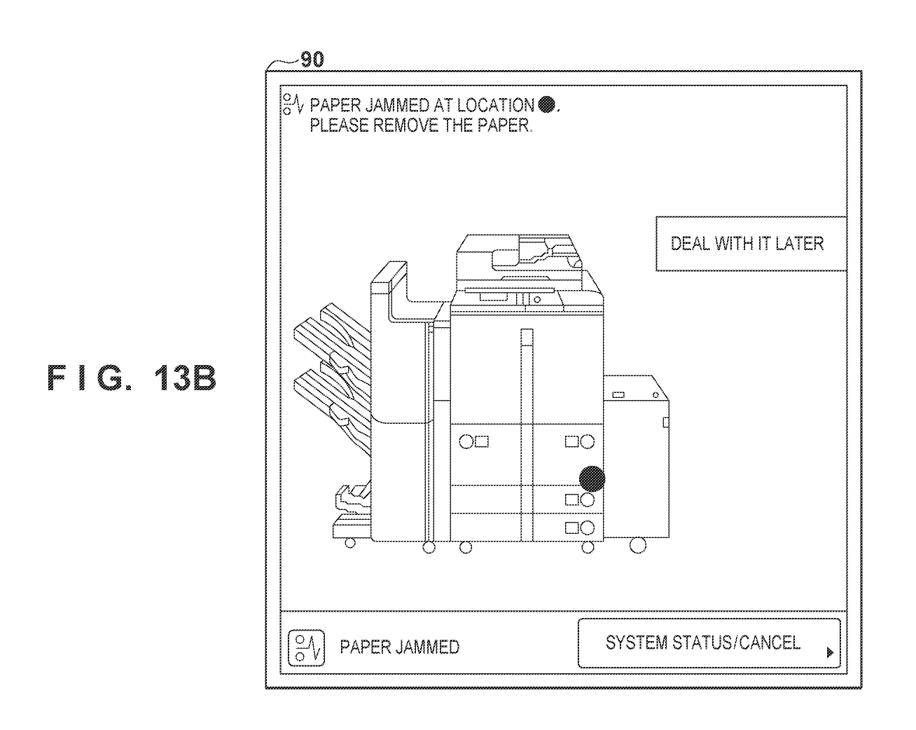

FIGS. 13A and 13B depict explanatory views of display data (UI window) as another embodiment, which is displayed in the common input display area 400. As mentioned above, FIG. 5A shows display data, which is stored in the flash ROM 3107, in a case where the FAX transmission function is selected. FIG. 13A shows a UI window displayed in the common input display area 400 when a copy key is selected in the basic mode window (FIG. 8), and thereafter a paper feed source is selected using the UI window of FIG. 13A.

FIG. 13B shows a UI window displayed in the common input display area 400, when paper jam occurs in copying or the like. In the display example in FIG. 13B, the location where paper is actually jammed is indicated.

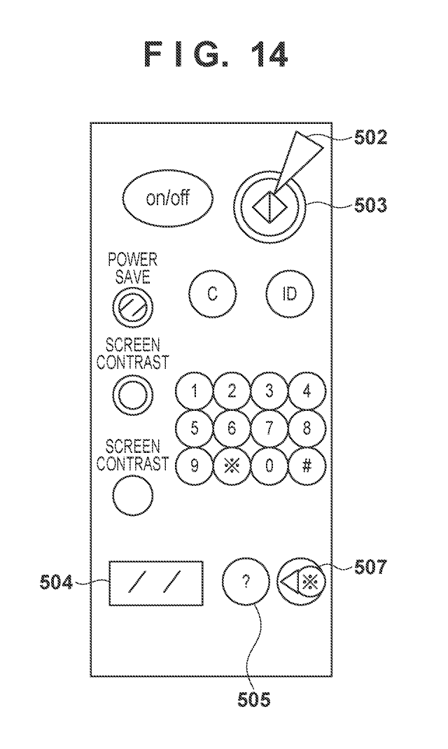

In this case, for instance, a key operation window shown in FIG. 14 is displayed in the horizontal input display area 402. In this key operation window, if the navigation key 505 for displaying a guide, such as an operation procedure, in the common input display area 400, or the register key 507 for registering various initial settings in the main unit 1000 is depressed, a corresponding UI window is displayed in the common input display area 400.

FIG. 14 shows a key operation window as another embodiment, which is displayed in the horizontal input display area 402.

In the vertical and horizontal input display areas shown in FIGS. 6A and 6B in the aforementioned embodiment, the same input keys are laid out independently for the portrait and landscape orientations. In comparison, in the horizontal input display area in FIG. 14, the keys are laid out in a way that the relative position relation of respective keys in the vertical display data shown in FIG. 6A can be maintained as much as possible. It is by nature impossible to have the exact same key layout in the portrait and landscape orientations. However, by maintaining the similar key positional relation in the portrait and landscape orientations, the difference in operability is kept to the minimum.

In the aforementioned embodiment, the tilt sensor 3113 is used for detecting the orientation of the console panel 3000 operated by an operator. In general, since the tilt sensor 3113 utilizes gravitation, if the console panel 3000 is placed on a horizontal surface, the tilt sensor 3113 cannot determine if the console panel 3000 is in a portrait or landscape orientation.

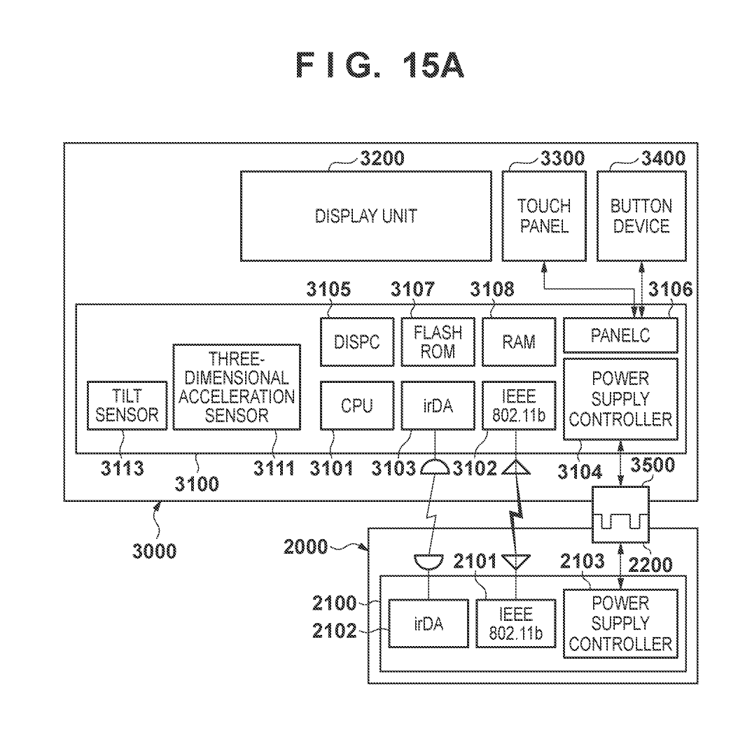

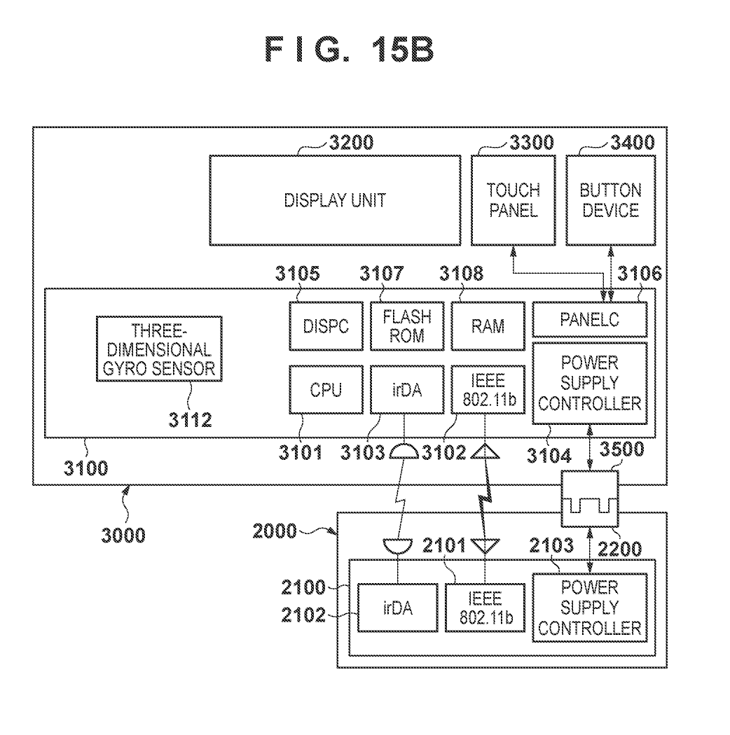

FIG. 15A is a block diagram of the console panel 3000 comprising a three-dimensional acceleration sensor 3111 in addition to the tilt sensor 3113 in the main board 3110, and the home position 2000.

FIG. 15B is a block diagram of the console panel 3000 comprising a three-dimensional gyro sensor in the main board 3110, and the home position 2000. In FIGS. 15A and 15B, components which are common to the aforementioned configuration of FIG. 2 are referred to by the same symbols, and description thereof is omitted. Note, in FIGS. 15A and 15B, the rechargeable battery 3120 is not shown.

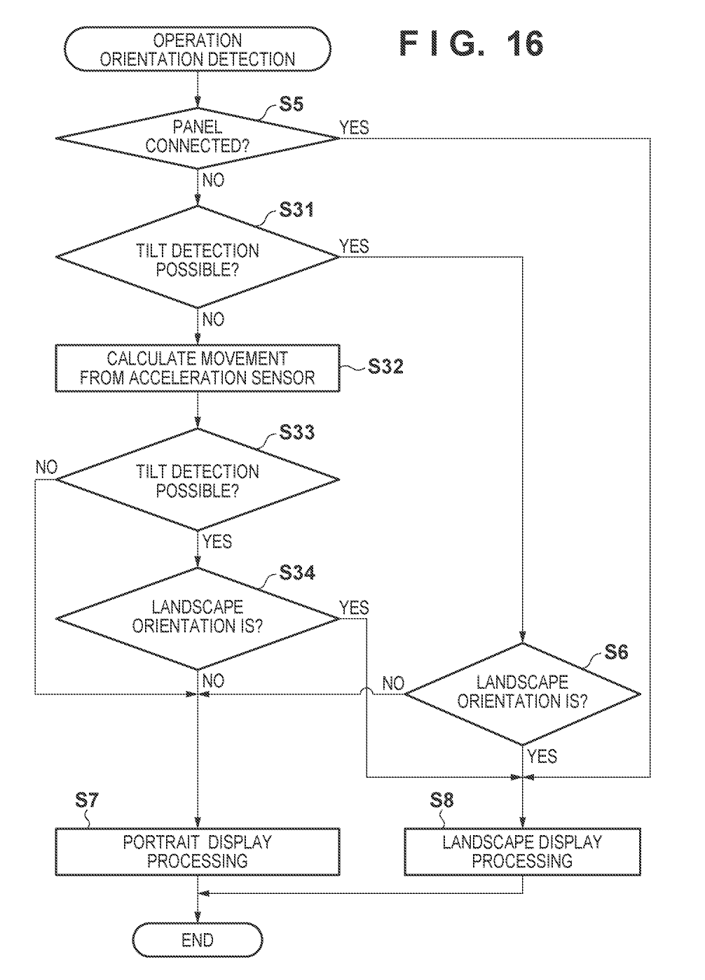

Orientation detection using the tilt sensor 3113 and the three-dimensional acceleration sensor 3111 as well as display processing is shown in the flowchart in FIG. 16. Processing similar to the above-described steps in FIG. 3 is referred to by the same step numerals, and description thereof is omitted.

In a case where the console panel 3000 is horizontally placed and an output of the tilt sensor 3113 is too small for stable detection, then it is determined that tilt detection is impossible and the processing proceeds from step S31 to S32, where an output of the acceleration sensor 3111 is processed for orientation detection. In this case, to detect an orientation, the output of the acceleration sensor 3111 is integrated twice, using the output of the tilt sensor 3113 as an initial value, for calculating a moving distance from the initial value with respect to each of the three-dimensional directions (step S32), and an orientation on the horizontal surface is determined.

Note, in the horizontal state, if the power of the console panel 3000 is turned on or the CPU 3101 is reset and the console panel 3000 has no movement, the tilt sensor 3113 determines that the tilt detection in step S33 is impossible, as the initial position is indefinite even with the use of the tilt sensor 3113. In this case, a landscape orientation is uniquely decided, and the processing proceeds to step S7.

Meanwhile, in step S33, if an amount of movement can be calculated based on an output of the acceleration sensor 3111, the processing proceeds to step S34, and in accordance with the determination result, the processing branches to step S7 or S8.

The three-dimensional gyro sensor 3112 shown in FIG. 15B does not have a disadvantage like the tilt sensor 3113 or the acceleration sensor 3111 in the foregoing two embodiments. In any state of the console panel 3000, the three-dimensional gyro sensor 3112 can detect the orientation of the console panel 3000 in accordance with the above-described flowchart in FIG. 3.

### OTHER EMBODIMENTS

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For instance, the above-described embodiments have described an image forming apparatus as an example of the display control apparatus, and the image forming apparatus main unit and the console panel are attachable/detachable as separate apparatuses. However, the present invention can be realized even if the display control apparatus and the console panel are integrated as a single apparatus. In other words, the present invention can be implemented by incorporating the above-described functions of the display control apparatus into the console panel.

As has been set forth above, according to the present embodiment, the display area of the display unit of the console panel is divided into the common input display area 400 and the vertical or horizontal input display area 401 or 402, and in accordance with a function designated by an operator, common display data (UI window or the like) for the function is displayed in the common input display area 400. Moreover, in accordance with a detection result of orientation of the console panel, substantially fixed display data, which is prepared in advance, such as a key operation window having arranged keys, is displayed in the vertical or horizontal input display area 401 or 402, separately from the common input display area 400.

By virtue of the above features, an operator can input instructions with common key operation, irrespective of the display window of the common input display area 400. Furthermore, the amount of display data for a UI window displayed in the common input display area 400, such as a menu window or an operation window displayed in the display unit of the console panel, can be kept to a small amount even if the types of UI windows to be displayed are increased.

Furthermore, even if, in the future, the aspect ratio of the display unit window is changed to a wide screen, for example, to a 16:9 ratio, the vertical or horizontal input display area 401 or 402 can deal with the change by simply increasing the area ratio to the common input display area 400. Moreover, by increasing the area ratio of the vertical or horizontal input display area 401 or 402, the keys become easier to see; therefore, better operability can be achieved.

This application claims the benefit of Japanese Patent Application No. 2010-265429, filed Nov. 29, 2010, which is hereby incorporated by reference herein in its entirety.

1. A display control apparatus for controlling display of a display unit, comprising:
detection means for detecting an orientation of the display unit; and
display control means for controlling display of the display unit in accordance with the orientation of the display unit, which is detected by said detection means,
wherein a screen of the display unit is divided into a first display area, where a display layout is changed in accordance with the orientation of the display unit, and a second display area where a display layout is not changed in accordance with the orientation of the display unit, and
said display control means does not let the first display area display, but makes the second display area display a first window which changes in accordance with a function to be executed, and does not let the second display area display, but makes the first display area display a second window which does not change in accordance with a function to be executed.

2. The display control apparatus according to claim 1, wherein the second window displayed in the first display area, which does not change in accordance with a function to be executed, is an operation window including at least a start key and numeric keys.

3. The display control apparatus according to claim 1, wherein the first window displayed in the second display area, which changes in accordance with a function to be executed, includes a setting window for inputting a setting related to at least any one of a copy function, which prints a scanned image, and a transmission function, which transmits a scanned image to a network.

4. The display control apparatus according to claim 1, wherein said detection means comprises at least one of a tilt sensor, a gyro sensor, or an acceleration sensor.

5. A control method of a display control apparatus for controlling display of a display unit, comprising:
a detection step of detecting an orientation of the display unit; and
a display control step of controlling display of the display unit in accordance with the orientation of the display unit, which is detected in said detection step,
wherein a screen of the display unit is divided into a first display area, where a display layout is changed in accordance with the orientation of the display unit, and a second display area where a display layout is not changed in accordance with the orientation of the display unit, and
said display control step does not let the first display area display, but makes the second display area display a first window which changes in accordance with a function to be executed, and does not let the second display area display, but makes the first display area display a second window which does not change in accordance with a function to be executed.

6. A non-transitory computer-readable storage medium, which stores a program for causing a computer to function as a display control apparatus which controls display of a display unit, said program causing a computer to function as a display control apparatus comprising:
detection means for detecting an orientation of the display unit; and
display control means for controlling display of the display unit in accordance with the orientation of the display unit, which is detected by the detection means,
wherein a screen of the display unit is divided into a first display area, where a display layout is changed in accordance with the orientation of the display unit, and a second display area where a display layout is not changed in accordance with the orientation of the display unit, and
said display control means does not let the first display area display, but makes the second display area display a first window which changes in accordance with a function to be executed, and does not let the second display area display, but makes the first display area display a second window which does not change in accordance with a function to be executed.
